(19) United States
(12) Patent Application Publication
(10) Pub. No.: US 2008/0153489 A1
(43) Pub. Date: Jun. 26, 2008

(54) APPARATUS AND METHOD FOR REDUCING SIGNALING OVERHEAD

(75) Inventor: Sun-Young LEE, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/950,910

(22) Filed: Dec. 5, 2007

(30) Foreign Application Priority Data
Dec. 5, 2006 (KR) 2006-121906

(51) Int. Cl. H04Q 7/20

(52) U.S. Cl. 455/435.1

(57) ABSTRACT

Provided is a method and apparatus for reducing signaling overhead. The method includes receiving information; when the received information is a signaling message, determining a Mobile Node sending the signaling message is one that newly moves into an area managed by a network apparatus; sending a binding update message to a Home Agent when the mobile node is one that newly moves into the area; when the received information is data, determining whether a Mobile Node to receive the data is in an idle state; buffering the received data, and multicasting a request message to lower nodes when the Mobile Node is in the idle state; receiving a reply message through a specific node of the lower nodes; and sending the buffered data through the specific node.

### PRIORITY

This application claims priority under 35 U.S.C. § 119 to an application filed in the Korean Intellectual Property Office on Dec. 5, 2006 and assigned Serial No. 2006-121906, the contents of which are incorporated herein by reference.

### BACKGROUND OF THE INVENTION

1. Field of the Invention

The present invention relates generally to a mobile Internet Protocol (IP), and in particular, to an apparatus and method for reducing signaling overhead, by using both Hierarchical Mobile IP (HMIP) and a Paging technology in one node.

2. Description of the Related Art

With development of the Internet, communication systems are evolving from circuit-based communication to packet-based communication. The Internet Protocol (IP) is used as a network layer protocol. Routing is required for the IP forwarding function, and is performed by a router. When a specific mobile node using the IP moves from an area of a certain router into a different area of another router (hereinafter, such an area will be referred to as a router area), an IP address of the mobile node has to be changed.

In detail, when the mobile node moves from one router area into another router area, a network connection with an existing IP address has to be converted into one with a different IP address in a TCP (Transmission Control Protocol)/UDP (User Datagram Protocol)-based program. In this case, if the program is a streaming-based application program, streaming of data is cut off.

To overcome this problem, Mobile IP has emerged, which allows a mobile node to move into another router area while maintaining the initially allocated IP address.

Mobile nodes using Mobile IP perform signaling for location registration when moved into another router area even when the mobile nodes are not in communication. However, since signaling is unnecessary for the mobile nodes that are not in communication, signaling in that case causes waste of network resources, and signaling overhead.

To solve the limitations of Mobile IP, research is ongoing on a Paging technology and Hierarchical Mobile IP (HMIP) for improving Mobile IP by using a hierarchical structure to reduce the signaling overhead.

FIG. 1 illustrates operations of typical HMIP and Paging.

Referring to FIG. 1, when moving into another Access Router (AR) area, a mobile node 190 receive a router advertisement message from the AR in step 1, and the mobile node 190 acquires a new Care of Address (CoA), and sends a binding update message indicating the new CoA to a home agent (HA) 130 and a Corresponding Node (CN) 140 in step 2. The AR and a paging agent 2 (PA2) (120) relay the binding update message in step 3 and 4.

When a Mobile Anchor Point (MAP) 110 determines from the binding update message that the mobile node 190 is one that newly moves into an area of the MAP 110 (i.e., MAP area), the MAP 110 sends the binding update message to the HA 130 and the CN 140.

However, when the MAP 110 determines from the binding update message that the mobile node 190 is not one that newly moves into the MAP 110 area but one that moves within the MAP area, the MAP 110 manages the location of the mobile node 190 without sending the binding update message to the HA 130 and the CN 140, and thus to reduce signaling overhead.

In the Paging technology, when the mobile node 190 moves into another AR area within an idle state (i.e., a state where the node exists on a network but is not in communication, which is the most common state), a Paging Agent (PA) 120 manages a location of the mobile node 190.

That is, in the Paging technology, a paging area is set, and a mobile node in an idle state, which moves within this area, does not send a binding update message. Paging Agents 120, 122, and 124 at the centers of respective paging areas manage Mobile Nodes in an idle state. Thereafter, when transited to a communication state, the mobile node 190 sends the binding update message.

FIG. 2 illustrates operations in the case where typical HMIP and Paging are used in combination.

Referring to FIG. 2, performance of a PA 220 in Paging, and performance of an MAP 210 in HMIP vary to a great extent depending on setting of areas where the PA 220 and the MAP 210 operate.

When a mobile node 290 is in idle mode, and the MAP 210 receives a data from the correspondent node (CN)(240) in step 1,2, the MAP 210 multicast a paging request message and the PA 220 and the AR relays the paging request message in step 3, 4, 5. The MAP 210 buffered the data.

Then, the mobile node 290 receives the paging request message, and sends a response message to the MAP 210 in step 6. The AR and the PA 220 relays the response message in step 7, 8.

The MAP 210 sends the buffered data to the mobile node 290 in step 9. The PA 220 and AR relay the buffered data in step 10, 11.

The PA 220 and the MAP 240 (hereinafter, respectively referred to as a paging area and an MAP area) choose areas in very similar manners. That is, the area choosing methods thereof are very similar in determining a paging area and an MAP area.

However, if the paging area and the MAP area are set to be different from each other, network overload may occur due to processes for setting the paging area and the MAP area, and operations of the PA 220 and the MAP 210 within the respective areas even though functions of the PA 220 and the MAP 210 are similar. Also, the network overload may result in data loss, thereby deteriorating communication quality.

### SUMMARY OF THE INVENTION

An object of the present invention is to substantially solve at least the above problems and/or disadvantages and to provide at least the advantages below. Accordingly, an object of the present invention is to provide an apparatus and method for reducing signaling overhead.

Another object of the present invention is to provide a network apparatus and a method for simultaneously performing functions of a Paging Agent (PA) and a Mobile Anchor Point (MAP).

Still another object of the present invention is to provide a network apparatus and a method for simultaneously performing functions of a PA and an MAP, so that a paging area and an MAP area become the same.

Further another object of the present invention is to provide a network apparatus and a method for simultaneously performing functions of a PA and an MAP, so that network overload is reduced to improve communication quality.

According to one aspect of the present invention, a method for reducing signaling overhead, includes receiving information; when the received information is a signaling message, determining if the signaling message is a binding update message and a mobile node sending the signaling message is one that newly moves into an area managed by a network apparatus; sending the binding update message to a home agent when the mobile node is one that newly moves into the area; when the received information is data, determining if a mobile node to receive the data is in an idle state; buffering the received data, and multicasting a request message to lower nodes when the mobile node is in the idle state; receiving a reply message through a specific node of the lower nodes; and sending the buffered data through the specific node.

According to another aspect of the present invention, a network apparatus for reducing signaling load includes an interface module supporting a communications function for communicating with another node; a mobile anchor point management unit receiving a signaling message through the interface module, and sending, when the signaling message is a binding update message and a mobile node sending the message is one that newly moves into an area managed by the network apparatus, the binding update message to a home agent; and a paging management unit receiving data through the interface module, buffering, when the mobile node to receive the data is in an idle state, the received data and multicasting a request message to lower nodes, and sending, when a reply message is received through a specific node of the lower nodes, the buffered data through the specific node.

According to still another aspect of the present invention, a network system for reducing signaling overhead includes a network apparatus receiving a signaling message, and sending, when the signaling message is a binding update message and a mobile node sending the message is one that newly moves into an area managed by the network apparatus, the binding update message to a home agent; and a mobile node sending a binding update message when the mobile node moves into another router area, wherein when the mobile node in an idle state moves within the area managed by the network apparatus, the mobile node does not send the binding update message.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates operations of typical HMIP and Paging.

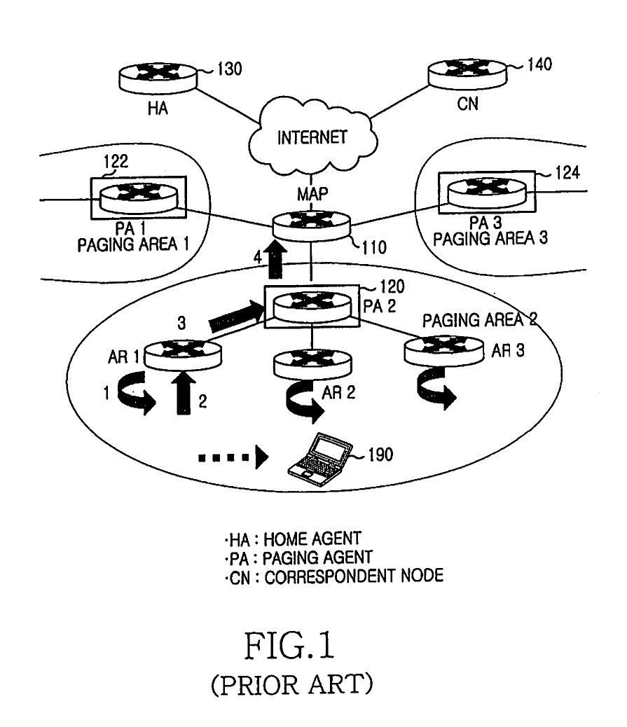

FIG. 2 illustrates operations in the case where typical HMIP and Paging are used in combination;

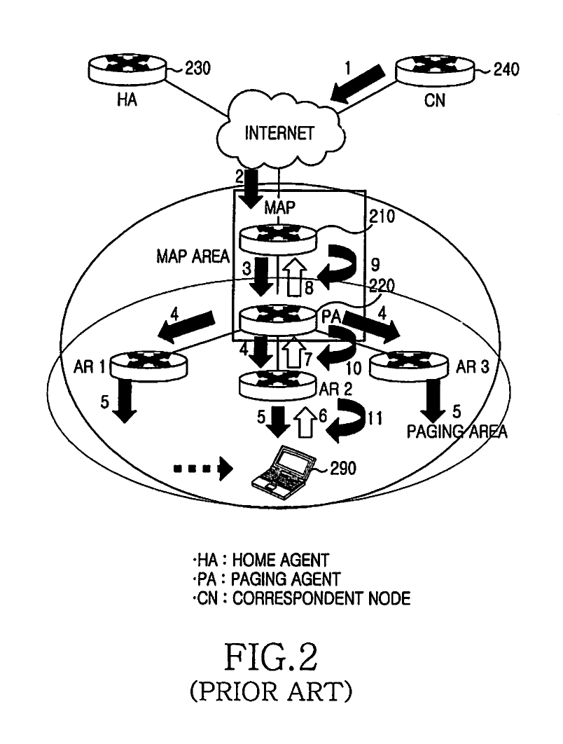

FIG. 3 illustrates merged operations of HMIP and Paging according to the present invention;

FIG. 4 is a flowchart showing an operational process of a network apparatus for merging operations of Paging and HMIP according to the present invention; and

FIG. 5 is a block diagram of a network apparatus for merging operations of Paging and HMIP according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

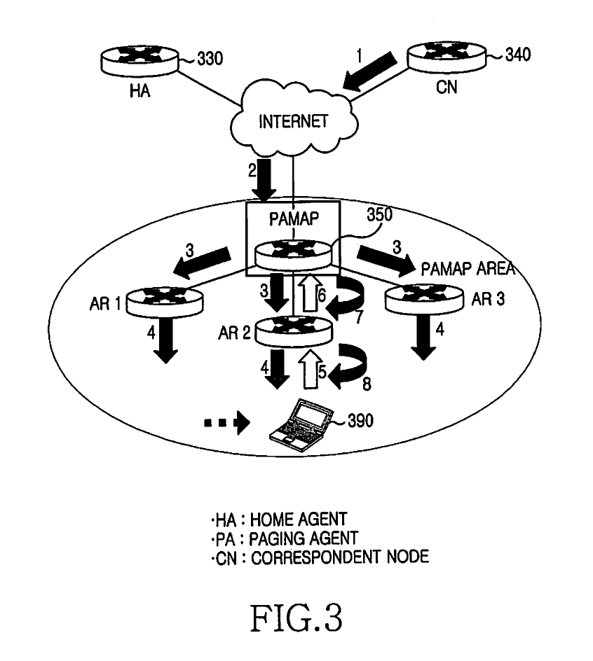

FIG. 3 illustrates merged operations of Paging and HMIP according to the present invention.

Referring to FIG. 3, a node which is referred to as a Paging Agent Mobile Anchor Point (PAMAP) node 350 is provided. The PAMAP node 350 serves functions of both a Paging Agent (PA) and a Mobile Anchor Point (MAP).

When a mobile node 390 is transited to an idle state, the mobile node 390 informs the PAMAP node 350 of the transition to the idle state. When a Corresponding Node (CN) 340 sends data to the mobile node 390 in the idle state in step 1,2, the PAMAP node 350 buffers the data, and multicasts a paging request message to all of routers within an area of the PAMAP node 350 in step 3, 4 (hereinafter, a PAMAP area). Then, the mobile node 390 having received the paging request message sends a reply message to the PAMAP node 350 to update its location in step 5, and is transited to an active state. An access router AR relays the reply message in step 6.

The PAMAP node 350 having received the reply message from the mobile node 390 sends the buffered data to the mobile node 390 in step 7. The AR relays the buffered data in step 8.

Thereafter, the mobile node 390 starts communication with the CN 340.

When the mobile node is not in the idle state, the PAMAP node 350 sends the data to the mobile node, without buffering the data.

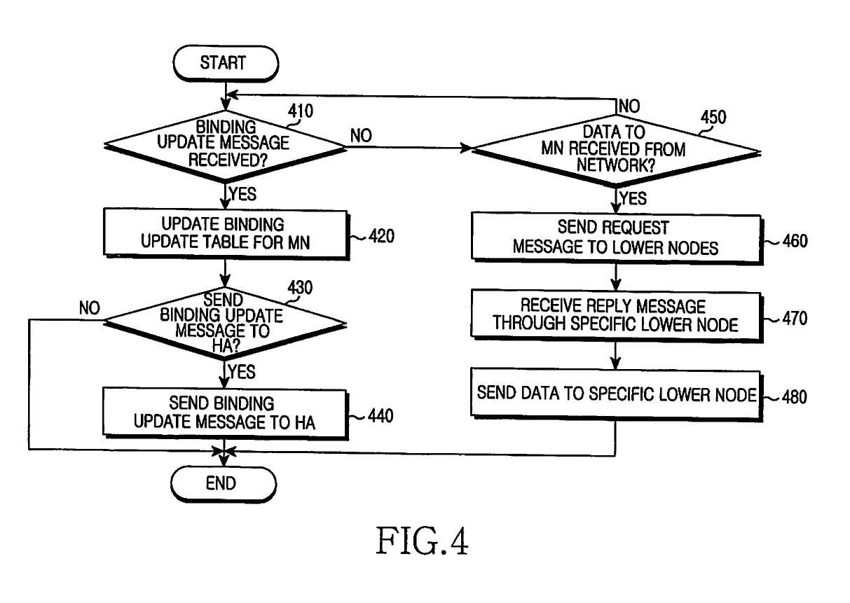

FIG. 4 is a flowchart showing an operational process of a network apparatus for merging operations of Paging and HMIP according to the present invention.

Referring to FIG. 4, in step 410, the network apparatus (i.e., PAMAP node) determines whether a binding update message is received from a Mobile Node (MN). This operation is performed when the MN moves into another router area.

In step 420, when the binding update message is received, the network apparatus updates a binding update table for the MN. That is, a previous care of address (CoA) of the Mobile Node is updated with a newly acquired CoA.

In step 430, it is determined whether to send the binding update message to a Home Agent (HA). That is, it is determined whether the MN is one that moves from another area into the area managed by the network apparatus.

In step 440, when it is determined to send the binding update message to the HA, the network apparatus sends the binding update message to the HA.

When the network apparatus receives data to be sent to the MN from a network without receiving the binding update data in step 450, that is, when data is received from the HA or a Corresponding Node (CN) through the network, the network apparatus sends a request message to lower nodes (lower routers) in step 460. The request message is a paging message that requests a reply from the MN.

When receiving the request message, the MN sends a reply message, and the network apparatus receives the reply message through a specific lower node in step 470. Through this operation, the network apparatus can be notified of information of the specific lower router to which the MN is currently connected.

In step 480, the network apparatus sends the data to the MN through the specific lower node. To sum up, in the request and reply processes, the network apparatus buffers the received data, determines the location of the MN, and then sends the data to the MN.

Thereafter, the process according to the present invention is completed.

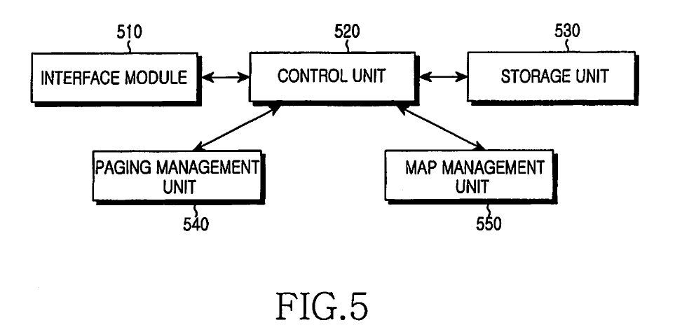

FIG. 5 is a block diagram of a network apparatus for merging operations of Paging and HMIP according to the present invention.

Referring to FIG. 5, an interface module 510 is a module for performing communication with another node, and includes a communication module and a baseband processing unit. The communication module converts a received signal to a baseband signal, and provides the baseband signal to the baseband processing unit. The baseband processing unit processes converted baseband signal and send the processed signal to a function unit, and also send the processed signal to the communication module vice verse for transmission to the outside.

A control unit 520 controls the overall operation of the network apparatus. For example, the control unit 520 provides a typical routing function for packet communication. According to the present invention, the control unit 520 controls a paging management unit 540 and an MAP management unit 550 so that the apparatus can serve as both a PA and an MAP.

The paging management unit 540 serves as a PA by indications and information provided from the control unit 520. That is, the paging management unit 540 manages a mobile node in an idle state within a management area. To this end, the paging management unit 540 buffers data that a corresponding node sends to the mobile node in an idle state, and multicasts a paging request message to all routers within an area thereof. When a reply message for a location update is received from the mobile node in response to the paging request message, the paging management unit 540 sends the buffered data to the mobile node.

The MAP management unit 550 serves as an MAP by indications and information provided from the control unit 520. When it is determined that the mobile node is not a node that newly moves into an area managed by the MAP management unit 550 but a node that moves within the area managed by the MAP management unit 550, the MAP management unit 550 does not send the binding update message to a home agent or a corresponding node, and manages a location of the mobile node.

A storage unit 530 serves to store programs for controlling the overall operation of the network apparatus, and temporary data generating during program execution.

Referring to FIG. 5, the control unit 520 may perform functions of the paging management unit 540 and the MAP management unit 550. Although those units are separately illustrated in the present invention, this is merely for individually describing functions thereof. Therefore, when an actual product is implemented, the control unit 520 may be configured to process all of the functions of the paging management unit 540 and the MAP management unit 550, or to process only a portion of the functions.

In the present invention, a Paging Agent Mobile Anchor Point (PAMAP) node is provided, which can perform functions of both a Paging Agent (PA) and a Mobile Anchor Point (MAP). Thus, generation of unnecessary signaling is reduced, so that signaling overhead in the network is reduced, and therefore communication quality is improved.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for reducing signaling overhead, the method comprising:
receiving information;
when the received information is a signaling message, determining whether a Mobile Node sending a signaling message is one that newly moves into an area managed by a network device;
sending a binding update message from the Mobile Node to a Home Agent when the Mobile Node is one that newly moves into the area;
when the received information is data, determining if a Mobile Node to receive the data is in an idle state;
buffering the received data, and multicasting a request message to lower nodes when the Mobile node is in the idle state;
receiving a reply message through a specific node of the lower nodes; and
sending the buffered data through the specific node.

2. The method of claim 1, wherein when the Mobile Node is not one that newly moves into the area, the binding update message is not sent to another node.

3. The method of claim 1, wherein when the Mobile Node is not in the idle state, the data is sent to the Mobile Node without being buffered.

4. A network apparatus for reducing signaling load, comprising:
an interface module supporting a communications function for communicating with another node;
a Mobile Anchor Point management unit receiving a signaling message through the interface module, and sending, when a mobile node sending a binding update message is one that newly moves into an area managed by the network apparatus, the binding update message to a Home Agent; and
a paging management unit receiving data through the interface module, buffering, when the Mobile Node which is to receive the data is in an idle state, the received data and multicasting a request message to lower nodes, and sending, when a reply message is received through a specific node of the lower nodes, the buffered data through the specific node.

5. The network apparatus of claim 4, wherein the Mobile Anchor Point management unit does not send the binding update message to another node when the Mobile Node is not one that newly moves into the area.

6. The network apparatus of claim 4, wherein the paging management unit sends the received data without buffering the data when the Mobile Node is not in the idle state.

7. A network system for reducing signaling overhead, comprising:
a network apparatus receiving a signaling message, and sending, when the signaling message is a binding update message and a Mobile Node sending the message is one that newly moves into an area managed by the network apparatus, the binding update message to a Home Agent; and
a Mobile Node sending a binding update message when the Mobile Node moves into another router area,
wherein when the Mobile Node in an idle state moves within the area managed by the network apparatus, the Mobile Node does not send the binding update message.

8. The network system of claim 7, wherein the network apparatus does not send the binding update message to another node when the Mobile Node is not one that newly moves into the area managed by the network apparatus.

9. The network system of claim 7, wherein the network apparatus receives data, buffers the received data and multicasts a request message to lower nodes when the Mobile Node to receive the data is in the idle state, and sends the buffered data through a specific node of the lower nodes when a reply message is received through the specific node.

10. The network system of claim 9, wherein when the Mobile Node is not in the idle state, the network apparatus sends the data to the mobile node, without buffering the data.

11. A method for reducing signaling overhead in a network device for merging operations of Paging and HMIP (Hierarchical Mobile Internet Protocol), the method comprising:
identifying a received information is a signaling message or a data;
when the received information is a signaling message, sending a binding update message from a Mobile Node to a Home Agent when the Mobile Node is one that newly moves into an area managed by the network device, and
when the received information is data, multicasting a request message to the Mobile Node when the Mobile node which is managed by the network device is in the idle state.

12. The method of claim 11, after the step of multicasting the request message to lower nodes, further comprising,
receiving a reply message from the Mobile Node; and
sending the buffered data to the Mobile Node.

13. The method of claim 11, wherein when the Mobile Node is not one that newly moves into the area, the binding update message is not sent.

14. An apparatus for reducing signaling overhead in a network device for merging operations of Paging and HMIP (Hierarchical Mobile Internet Protocol), the apparatus comprising:
means for identifying a received information is a signaling message or a data;
means for, when the received information is a signaling message, sending a binding update message from a Mobile Node to a Home Agent when the Mobile Node is one that newly moves into an area managed by the network device, and
means for, when the received information is data, multicasting a request message to the Mobile Node when the Mobile node which is managed by the network device is in the idle state.

15. The apparatus of claim 14, further comprising,
means for receiving a reply message from the Mobile Node; and
means for sending the buffered data to the Mobile Node.

16. The apparatus of claim 14, wherein when the Mobile Node is not one that newly moves into the area, the binding update message is not sent.
